(19) United States
(12) Patent Application Publication
(10) Pub. No.: US 2025/0240112 A1
(43) Pub. Date: Jul. 24, 2025

(54) NETWORK MEASUREMENT SYSTEM AND A NETWORK MEASUREMENT METHOD

(71) Applicant: ANRITSU CORPORATION, Atsugi-shi (JP)

(72) Inventors: Atsushi FURUKI, Atsugi-shi (JP); Junya ODA, Atsugi-shi (JP); Mitsuhiro USUBA, Atsugi-shi (JP)

(21) Appl. No.: 18/972,142

(22) Filed: Dec. 6, 2024

(30) Foreign Application Priority Data
Jan. 22, 2024 (JP) 2024-007175

(51) Int. Cl. H04J 3/06; H04W 56/00

(52) U.S. Cl. CPC H04J 3/0682; H04J 3/0661; H04W 56/0055

(57) ABSTRACT

The network measurement system has a first network measurement device and a second network measurement device respectively having a GNSS receiving function, and with the first network measurement device connected to the UE and the second network measurement device arranged outside the data center and connected to the server device, both devices measure the one-way delay between the UE and the server device. In accordance with this, the second network measurement device simultaneously measures the one-way delay and two-way delay between the server device and estimates the time error of the server device based on the results of the one-way delay and two-way delay measurements.

### CROSS-REFERENCE TO RELATED APPLICATIONS

The present application claims Convention priority to Japanese Patent Application No. 2024-007175, filed Jan. 22, 2024, the entire contents of which are incorporated herein by reference.

### FIELD OF THE INVENTION

The present invention relates to a network measurement system and a network measurement method that performs one-way delay measurement for a desired section of a communication network.

### BACKGROUND ART

Some network measurement systems are equipped with a measurement function for the communication network, such as an OWD measurement function for measuring the one-way delay (OWD) in a desired section, and a time error measurement (estimation) function for measuring packet time error (TE).

In order to perform one-way delay measurement of a communication network in a network measurement system, it is necessary to place multiple units equipped with network measurement functions at desired locations, such as the transmission and reception sides of packet transmission, and have each units share a common clock.

As an example of a network measurement device that enables operation using a common clock, there is conventionally known a portable device that measures a 5G network (5th Generation Mobile Communication System) that operates in time synchronization with reference time information acquired from a GNSS (Global Navigation Satellite System) satellite, moves sequentially to desired test locations, connects to one of multiple base stations at each test location, begins positioning at the test location based on received signal information from the GNSS satellite, and measures the performance of the 5G network after realizing time synchronization with the GNSS satellite (see, for example, Patent Document 1).

### PRIOR ART DOCUMENTS

### Patent Documents

[PATENT DOCUMENT 1] JP 2023-37994 A

### SUMMARY OF THE INVENTION

### Problems to be Solved by the Invention

The conventional network measurement device described in Patent document 1 is configured as a portable device, and adjusts the GNSS antenna and receiving position each time it moves to a test location, and starts measurement only after it is possible to reliably acquire received signal information from GNSS satellites (after time synchronization is reliably acquired).

On the other hand, in a system configuration in which multiple units are arranged at various positions in a communication network to perform the one-way delay measurements, one example of a method for making the underlying clock common to each unit is to use a GNSS receiver to acquire, for example, Coordinated Universal Time (UTC) and use it as a common clock.

However, in the system configuration described above, it is not necessarily possible to acquire signals from GNSS in all environments. For example, in a communication network, one end of a one-way delay section may be a device (e.g., a user terminal) arranged outdoors, and even though it is possible to acquire time information from GNSS satellites at the location corresponding to this end, the device at the other end of the one-way delay section (e.g., a server device) may be provided inside a data center, where the environment may make it difficult to acquire time information from GNSS satellites at the location corresponding to this other end. In such an environment, even if a unit is arranged corresponding to each device at both ends of the one-way delay section, it is not possible to acquire, for example, UTC as a common clock on the device placed in the data center, and as a result of not being able to share a common clock between both devices, it is inevitable that the accuracy of the one-way delay measurement will decrease.

Thus, in conventional network measurement systems, it is difficult to perform high-precision one-way delay measurement in an environment where it is difficult for a device at one end of a one-way delay measurement section of a communication network to acquire time information from a GNSS satellite, or so-called time information synchronized with UTC.

The present invention has been made in consideration of the above-mentioned circumstances, and aims to provide a network measurement system and a network measurement method that can accurately measure the one-way delay of a one-way delay measurement section, even in an environment where it is difficult for a device at one end of the one-way delay measurement section of a communication network to acquire time information synchronized with UTC, for example.

### Means to Solve the Problem

In order to solve the above problem, the network measurement system according to claim 1 of the present invention is a Network measurement system for measuring one-way delay (OWDᵤₚ, OWD_{down}) in a one-way delay measurement section between a terminal (10) and a server device (22), connected to a network, wherein the server device and the terminal respectively have an acquisition means (52) for acquiring time information as a common clock, and the system comprises a first network measurement device (50A) and a second network measurement device (50B) that are connected to the terminal or the server device and measure the one-way delay in an environment subjected to the time information acquired from a clock (28) of the server device, wherein the first network measurement device and the second network measurement device further comprising: a delay measurement control means (62) for performing a one-way delay measurement based on a delay measurement signal for time error measurement and a two-way delay measurement in parallel with the server device in conjunction with the one-way delay measurement while connected to the server device; and a time error estimation means (63) for estimating a time error (Tₑᵣᵣ) of the server device reflecting the time error between the time information of the common clock acquired by the acquisition means and the time information acquired from the clock of the server device, based on the measurement results (OWD_{te-down}, OWDₜₑ₋ᵤₚ, and TWDₜₑ) of the one-way delay measurement and the two-way delay measurement performed by the delay measurement control means.

By this configuration, the network measurement system according to claim 1 of the present invention can operate in an environment equivalent to when both network measurement devices can acquire time information from a common clock, even in an environment where one end of the one-way delay measurement section (for example, the server device side) has difficulty acquiring time information from a common clock, by correcting the one-way delay due to the time error of the server device's clock. This makes it possible to perform estimation of the time error of the one-end device while performing one-way delay measurement of the one-way delay measurement section under conditions of high time accuracy, and to perform accurate measurement of one-way delay taking into account the time error estimation result.

Further, in the network measurement system according to claim 2 of the present invention, the common clock may be configured to be a Coordinated Universal Time (UTC).

By this configuration, the network measurement system according to claim 2 of the present invention can operate in an environment equivalent to when both network measurement devices can acquire time information synchronized with UTC. This makes it possible to perform estimation of the time error of the one-end device while performing one-way delay measurement of the one-way delay measurement section under conditions of high time accuracy, and to perform accurate measurement of one-way delay taking into account the time error estimation result.

Further, the network measurement system according to claims 3 and 4 of the present invention, the network may be configured to be a communication network (1) comprising a core network of a predetermined communication method and an access network for enabling the terminal to access the core network, wherein the server device is connected to the core network, is arranged within the data center (30), and measures the one-way delay related to data transmission between the terminal and the server device.

By this configuration, the network measurement system according to claims 3 and 4 of the present invention can accurately measure the one-way delay between a server device in a data center and a terminal at the edge of the network via a communication network.

Further, in the network measurement system according to claims 5 and 6 of the present invention, the access network may be configured to comprise a base station (11) that accommodates the terminal to enable communication, and the base station and the terminal are connected either by wire or wirelessly.

By this configuration, the network measurement system according to claims 5 and 6 of the present invention can measure the one-way delay between a terminal and a server device in the communication network in the similar procedure, regardless of whether the base station and the terminal are connected by wire or wirelessly in the access network.

Further, in the network measurement system according to claims 7 and 8 of the present invention, the core network may be configured to be constituted by one of private 5G, local 5G, and 5G core networks.

By this configuration, the network measurement system according to claims 7 and 8 of the present invention can perform more accurate one-way delay measurements for communication networks including core networks such as private 5G, local 5G, and 5G core networks.

Further, in the network measurement system according to claims 9 and 10 of the present invention, the first network measurement device and the second network measurement device may be configured to comprise a transceiver unit (58) that conforms to a predetermined communication standard and are connected to the terminal or the server device via the communication network.

By this configuration, the network measurement system according to claims 9 and 10 of the present invention can easily construct a system configuration for performing one-way delay measurements between a terminal and a server device, and one-way and two-way delay measurements between a server device.

Further, in the network measurement system according to claims 11 and 12 of the present invention, the delay measurement control means may be configured to perform one-way delay measurements in the one-way delay measurement section for a predetermined period and at a predetermined time interval, and outputs an average value of the one-way delay measurements in the period as the one-way delay measurement result.

By this configuration, the network measurement system according to claims 11 and 12 of the present invention can reduce the impact of the variations and eliminate the uncertainty of the one-way delay of the communication network, even if extreme variations occur in the one-way measurements for the one-way delay measurement section.

Further, in the network measurement system according to claims 13 and 14 of the present invention, the delay measurement control means may be configured to control not to output the one-way delay measurement result when the average value exceeds a predetermined threshold.

By this configuration, the network measurement system according to claims 13 and 14 of the present invention can prevent the one-way delay measurement result from fluctuating beyond a predetermined threshold, allowing for highly accurate one-way delay measurement while also reducing the impact of time errors on the estimated results.

Further, the network measurement system according to claims 15 and 16 of the present invention may be further configured to comprise a data analysis processing device (70, 70A) arranged to be capable of communicating with the first network measurement device and the second network measurement device, the data analysis processing device comprising: a collection means (71) for collecting a downlink one-way delay measurement result (OWD_{down}) from the server device to the terminal by the first network measurement device, an uplink one-way delay measurement result (OWDᵤₚ) from the terminal to the server device by the second network measurement device, and a time error estimation result (TWDₜₑ) of the server device; and a one-way delay correction means (72) for analyzing the downlink one-way delay measurement result, the uplink one-way delay measurement result, and the time error estimation result of the server device collected by the collection means, and correcting the downlink one-way delay measurement result and the uplink one-way delay measurement result based on the time error estimation result of the server device.

By this configuration, the network measurement system according to claims 15 and 16 of the present invention can easily correct the downlink one-way delay measurement results and the uplink one-way delay measurement results based on the time error estimation result of the server device after the one-way delay correction means of the data analysis processing device analyzes the downlink one-way delay measurement results, the uplink one-way delay measurement results and the time error estimation result of the server device collected by the collection means, thereby achieving more accurate one-way delay measurement.

Further, in the network measurement system according to claims 17 and 18 of the present invention, the data analysis processing device (70A) may be configured to be provided in the server device constituting the communication network.

By this configuration, the network measurement system according to claims 17 and 18 of the present invention can achieve a system configuration for achieving accurate one-way delay measurement simply and inexpensively by arranging the data analysis processing device inside the server device.

Further, in the network measurement system according to claims 19 and 20 of the present invention, the data analysis processing device (70) may be configured to be arranged outside the communication network so as to be able to communicate with the first network measurement device and the second network measurement device.

By this configuration, the network measurement system according to claims 19 and 20 of the present invention can arrange the data analysis processing device in any position away from the first network measurement device and the second network measurement device, improving flexibility in constructing a system for achieving accurate one-way delay measurement.

In order to solve the above problem, the network measurement method according to claim 21 of the present invention is a network measurement method for measuring one-way delay (OWDᵤₚ, OWD_{down}) in a one-way delay measurement section between the terminal connected to the network and the server device using the network measurement system according to claim 1, comprising: a connection step (S1) for connecting the first network measurement device to the terminal and the second network measurement device to the server device; one-way delay measurement steps (S4-S6) for measuring the one-way delay in the one-way delay measurement section in an environment in which the first network measurement device and the second network measurement device are subjected to the time information acquired from the clock (28) of the server device; delay measurement control steps (S11, S12) in which the second network measurement device performs both one-way delay measurement and two-way delay measurement in parallel, based on the delay measurement signal for time error measurement between the second network measurement device and the server device, in conjunction with the one-way delay measurement in the one-way delay measurement section; and a time error estimation step (S13) for estimating a time error (Tₑᵣᵣ) of the server device that reflects the time error between the time information of the common clock acquired by the acquisition means and the time information acquired from the clock of the server device, based on the measurement results (OWD_{te-down}, OWDₜₑ₋ᵤₚ, and TWDₜₑ) of the one-way delay measurement and the two-way delay measurement by the delay measurement control step.

By this configuration, the network measurement method according to claim 21 of the present invention can operate in an environment equivalent to when both network measurement devices can acquire time information from a common clock, even in an environment where one end of the one-way delay measurement section (for example, the server device side) has difficulty acquiring time information from a common clock, by correcting the one-way delay due to the time error of the server device's clock. This makes it possible to perform estimation of the time error of the one-end device while performing one-way delay measurement of the one-way delay measurement section under conditions of high time accuracy, and to perform accurate measurement of one-way delay taking into account the time error estimation result.

### Effect of the Invention

The present invention can provide a network measurement system and a network measurement method that can accurately measure the one-way delay of a one-way delay measurement section, even in an environment where it is difficult for the devices at one end of the one-way delay measurement section of a communication network to acquire time information synchronized with UTC, for example, as a common clock.

### BRIEF DESCRIPTION OF THE DRAWINGS

FIG. 1 A diagram showing the arrangement of a first network measurement device and a second network measurement device constituting a network measurement system according to one embodiment of the present invention in a communication network.

FIG. 2 A block diagram showing the configuration of a first network measurement device in a network measurement system according to one embodiment of the present invention.

FIG. 3 A block diagram showing the configuration of a second network measurement device in a network measurement system according to one embodiment of the present invention.

FIG. 4 A block diagram showing the configuration of a server device to which a second network measurement device in a network measurement system according to one embodiment of the present invention is connected.

FIG. 5 A flowchart showing the one-way delay measurement processing operation of a communication network by a network measurement system according to one embodiment of the present invention.

FIG. 6A A diagram showing the control sequence between a second network measurement device and a server device in a network measurement system according to one embodiment of the present invention, showing the control sequence of the one-way delay measurement.

FIG. 6B A diagram showing the control sequence between a second network measurement device and a server device in a network measurement system according to one embodiment of the present invention, showing the control sequence of the two-way delay measurement.

FIG. 6C A diagram showing the control sequence between a second network measurement device and a server device in a network measurement system according to one embodiment of the present invention, showing the control sequence of the time error estimation of the server device.

FIG. 7 A diagram showing a first arrangement of a data analysis processing device equipped with a one-way delay correction function in a network measurement system according to one embodiment of the present invention.

FIG. 8 A diagram showing a second arrangement of a data analysis processing device equipped with a one-way delay correction function in a network measurement system according to one embodiment of the present invention.

FIG. 9 An image diagram showing a data transmission path and a structure of transmission data corresponding to a one-way delay measurement section of a communication network shown in FIG. 1 in which a network measurement system according to one embodiment of the present invention is arranged.

FIG. 10 A table showing one-way delay and time error estimation results in the arrangement shown in FIG. 9 by a network measurement system according to one embodiment of the present invention.

FIG. 11 A graph showing one-way delay and time error estimation results in the arrangement shown in FIG. 9 by a network measurement system according to one embodiment of the present invention.

FIG. 12 A diagram showing an example of the configuration of another communication network to which the network measurement system according to the present invention can be applied.

### DETAILED DESCRIPTION OF EMBODIMENTS

(Summary of the present invention) The network measurement system according to the present invention measures the delay between an application in a data center via a network. Specifically, the network measurement system according to the present invention is adapted to measure the one-way delay between a device (for example, a server device) that executes an application and an edge that connects a terminal, which is connected to the network.

The network measurement system according to the present invention is configured with network measurement devices that are arranged corresponding to the server device and the terminals connected to the network. Here, the server device comprises a clock, but this clock may have a time error between the clocks assumed by the two network measurement devices. The network measurement system according to the present invention has a function to correct the error in the one-way delay measurement result caused by the time error.

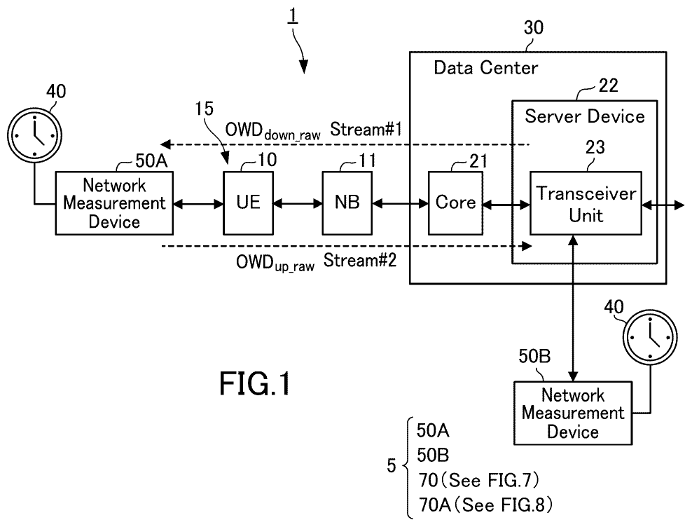

(Embodiment) Hereinafter, an embodiment of the network measurement system and network measurement method according to the present invention will be described with reference to the drawings. First, the configuration of the communication network 1 that is the measurement target of the one-way delay measurement by the network measurement system 5 according to one embodiment of the present invention will be described with reference to FIG. 1. In particular, FIG. 1 illustrates a configuration in which the measurement target is 5G, and the core network 21 and the server device 22 of the communication network 1 are provided in the same data center 30. Note that the communication network 1 is merely one example of the communication network that is the measurement target of the network measurement system 5 according to the present embodiment, and is not limited to the configuration shown in FIG. 1. For example, the measurement target may be other than 5G, and the communication network 1 may be provided with the core network 21 and the server device 22 arranged in separate data centers 31 (see FIG. 12).

As shown in FIG. 1, the communication network 1 comprises a user equipment (UE: User Equipment) 10, a base station (NodeB: NB) 11, a core network 21 having a predetermined communication method, and a server device 22, and is configured so that the UE 10 and the server device 22 arranged in the data center 30 can transceive packets for delay measurement.

In the communication network 1, the UE 10 may be, for example, a mobile communication terminal such as a smartphone, a PC (personal computer), or various other communication devices compatible with 5G. The UE (user equipment) 10 constitutes the terminal of the present invention. The base station 11 may be, for example, a base station eNB (eNodeB) for 4G (4th Generation Mobile Communication System) or a base station gNB for 5G. The base station 11 is provided outside the data center 30.

On the other hand, the core network 21 is provided within the data center 30. The core network 21 can adopt any of private 5G (5th Generation Mobile Communication System), local 5G, 5G core networks, and the like., depending on the specifications of the UE 10 and the base station 11.

The data center 30 is provided within a building, and has a server device 22 comprising a transceiver unit 23 that transceives data to and from the UE 10 via the base station 11 and the core network 21 (provided within the data center 30).

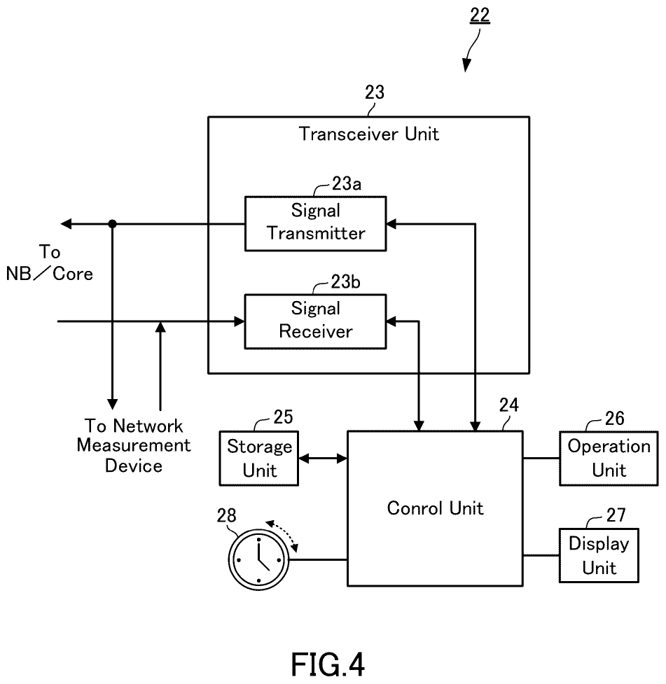

In addition to the transceiver unit 23, the server device 22 comprises functional blocks such as a control unit 24 and a storage unit 25 (see FIG. 4). The control unit 24 is constituted by a computer device, and by executing a control program stored in the storage unit 25, for example, causes the server device 22 to function as a device capable of providing communication services such as a data providing service that receives access from various clients and provides the requested data to the clients, and a connection service that connects the client to the requested access destination based on the access.

In the communication network 1 having the above configuration, the UE 10 can access the server device 22 as necessary and use the communication service provided by the server device 22. In order to smoothly operate this communication service, the UE 10 needs to meet the capability requirements for the communication service in advance. Prior to such operation, the network measurement system 5 is used to evaluate the above-mentioned capability of the UE 10. The network measurement system 5 sets, for example, a data transmission section from the UE 10 to the server device 22 in the communication network 1 as a one-way delay measurement section, and performs one-way delay measurement in the one-way delay measurement section. The measurement result of this one-way delay measurement is used to evaluate the capability of the UE 10.

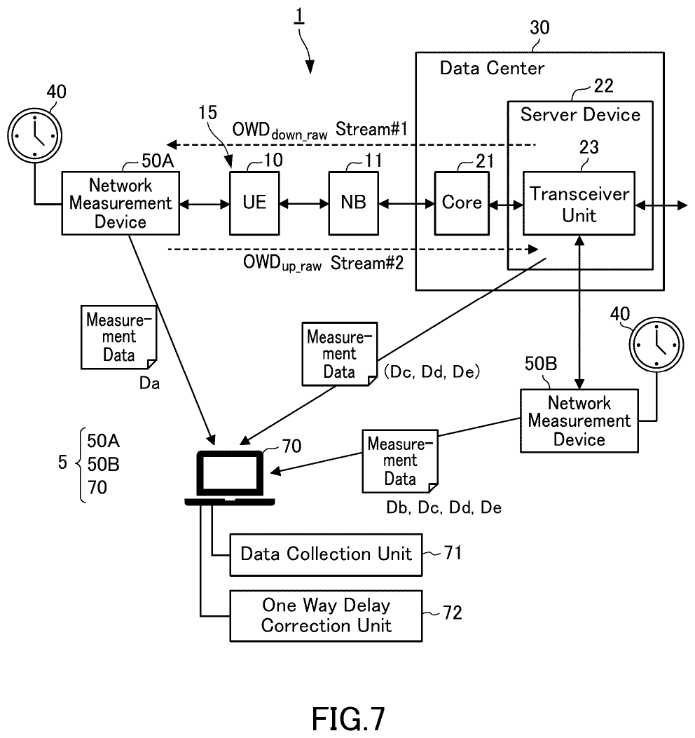

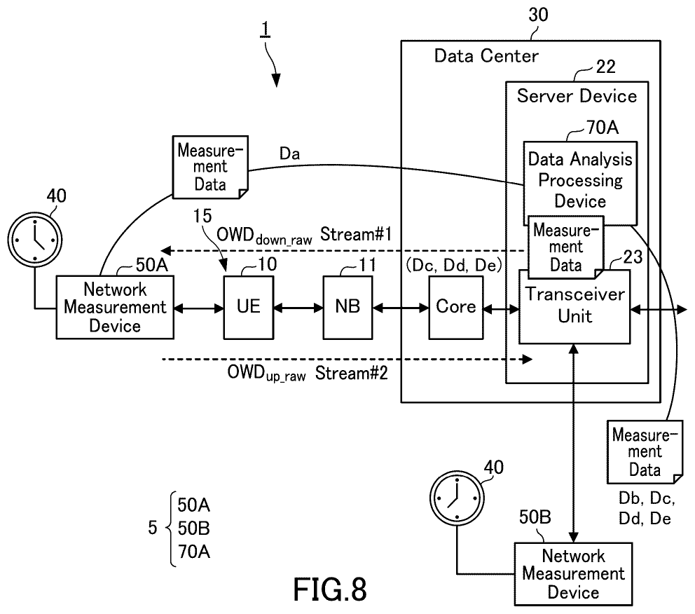

As shown in FIG. 1, the network measurement system 5 according to the present embodiment is configured to comprise network measurement device 50A and network measurement device 50B. Although not shown in FIG. 1, the network measurement system 5 according to the present embodiment is further configured to comprise data analysis processing devices 70, 70A that collect and analyze measurement data related to one-way delay measurement from the network measurement devices 50A, 50B, as will be described in detail later (see FIGS. 7 and 8).

The network measurement devices 50A, 50B have the same configuration, and are operated by being arranged (connected) at both ends (the UE 10 side or the server device 22 side) of the one-way delay measurement section described above. For example, when network measurement devices 50A and 50B are arranged on the UE 10 side, they control the transmission of a one-way delay measurement signal (measurement packet) from UE 10, and when arranged on the server device 22 side, they capture the one-way delay measurement signal transmit from UE 10 on the transmission path of server device 22 and measure the uplink one-way delay (OWDᵤₚ) in the delay measurement section. This measurement of the uplink one-way delay (OWDᵤₚ) is performed, for example, using Stream #2 in communication network 1.

Further, in the similar connection state as above, for example, network measurement device 50B (or network measurement device 50A) arranged on the server device 22 side can control the server device 22 to transmit a one-way delay measurement signal, and network measurement device 50A (or network measurement device 50B) arranged on the UE 10 side can capture the one-way delay measurement signal received by UE 10 and measure the downlink one-way delay (OWD_{down}) in the delay measurement section. This measurement of the downlink one-way delay (OWD_{down}) is performed, for example, using Stream #1 in communication network 1. Network measurement devices 50A and 50B respectively constitute the first network measurement device and second network measurement device of the present invention.

Both network measurement devices 50A and 50B have a GNSS receiving function (GNSS receiver 52). Both network measurement devices 50A and 50B acquire UTC from GNSS reception information (however, if they are arranged corresponding to the server device 22, they must be arranged outside the data center 30), and can be used as a common clock in one-way delay measurement. Note that, as an embodiment of the present invention, an example in which UTC is acquired and used as a common clock will be described, but as long as it can be used as a common clock, it is not limited to UTC. For example, it may be configured to use Japan Standard Time (JST) or other standards as the common clock.

It should be noted that, in the configuration of the network measurement devices 50A and 50B, the GNSS reception function is given as an example of an effective component for performing measurement processing in synchronization with a highly accurate clock synchronized with UTC. As another configuration for achieving measurement processing in synchronization with a highly accurate clock synchronized with UTC, for example, a configuration equipped with NTP (Network Time Protocol) or PTP (Precision Time Protocol) is also possible.

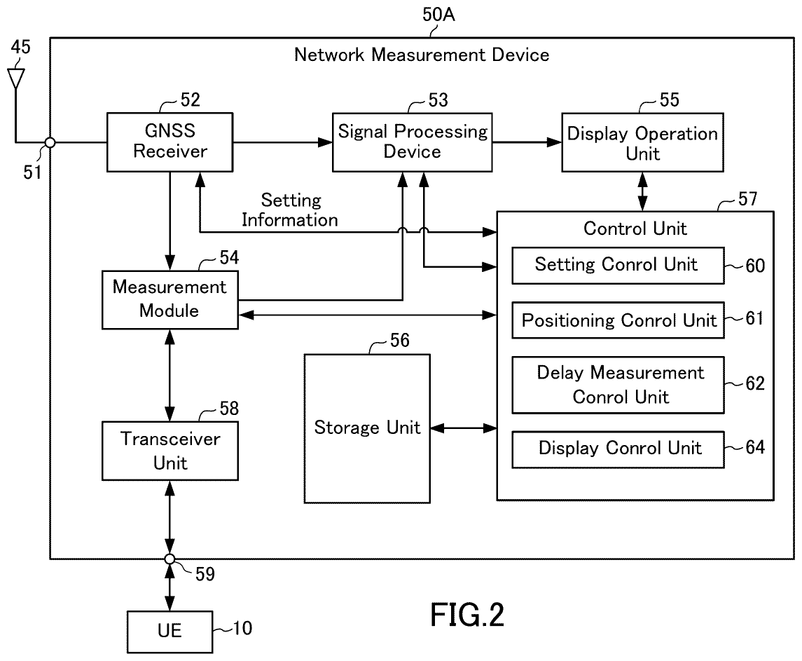

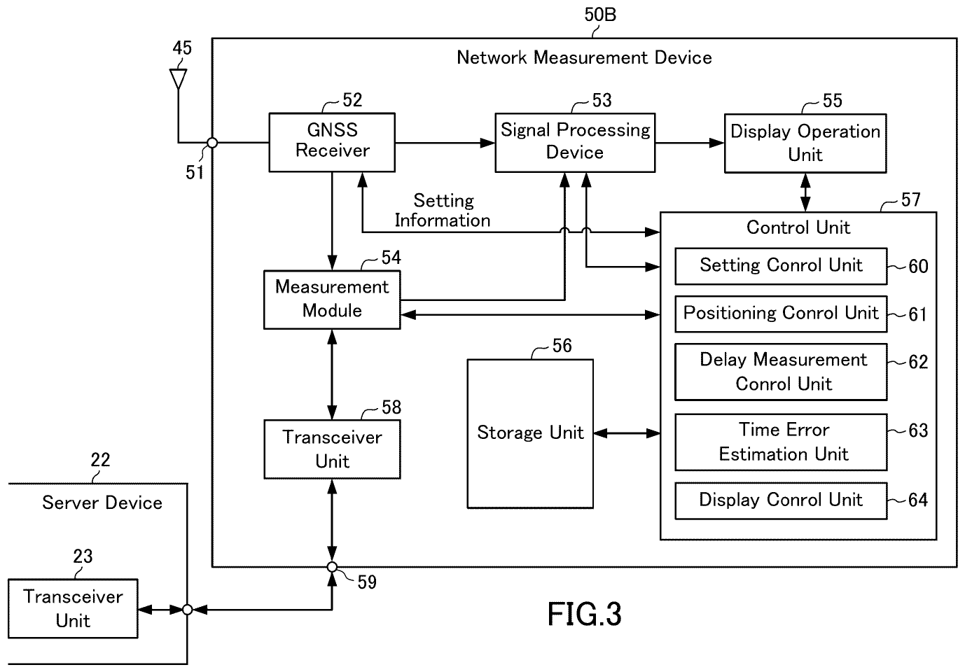

The detailed configuration of the network measurement devices 50A and 50B will be described with reference to FIGS. 2 and 3. FIG. 2 shows the configuration of the network measurement device 50A, and FIG. 3 shows the configuration of the network measurement device 50B. In FIG. 2, a configuration is shown assuming that the network measurement device 50B is connected to the server device 22, while the network measurement device 50A is connected to the UE 10 via the network measurement terminal 59 and operated.

(Network measurement device 50A) As shown in FIG. 2, the network measurement device 50A is configured to comprise an antenna input terminal 51, a GNSS receiver 52, a signal processing device 53, a measurement module 54, a display operation unit 55, a storage unit 56, a control unit 57, a transceiver unit 58, and a network measurement terminal 59.

The antenna input terminal 51 is a terminal for inputting a received signal received by the GNSS antenna 45 for receiving a signal transmitted from a GNSS satellite. The network measurement device 50A has a configuration in which the GNSS antenna 45 can be attached and detached to the antenna input terminal 51.

The GNSS receiver 52 inputs the signal received by the GNSS antenna 45 and outputs it to the signal processing device 53 and the measurement module 54 as received signal information of the GNSS satellite. The GNSS receiver 52 constitutes the acquisition means of the present invention.

The signal processing device 53 is a functional unit that inputs received signal information from GNSS satellites output by the GNSS receiver 52, performs various signal processing based on the received signal information, and transmits the processing results to the display operation unit 55. The signal processing device 53 executes positioning processing to calculate information such as the latitude, longitude, and altitude of the location based on the received signal information, and outputs each of these pieces of information as positioning information.

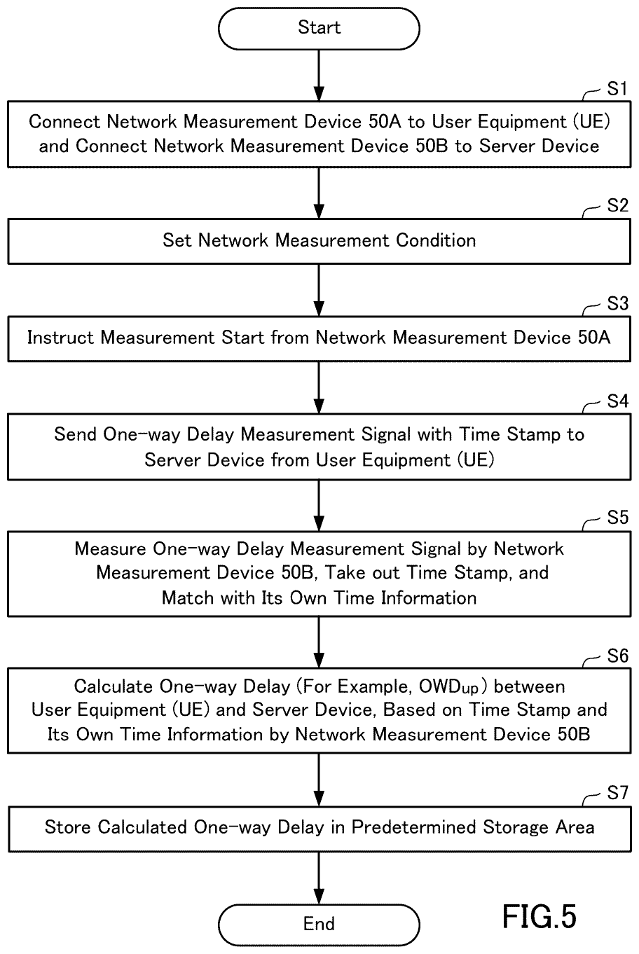

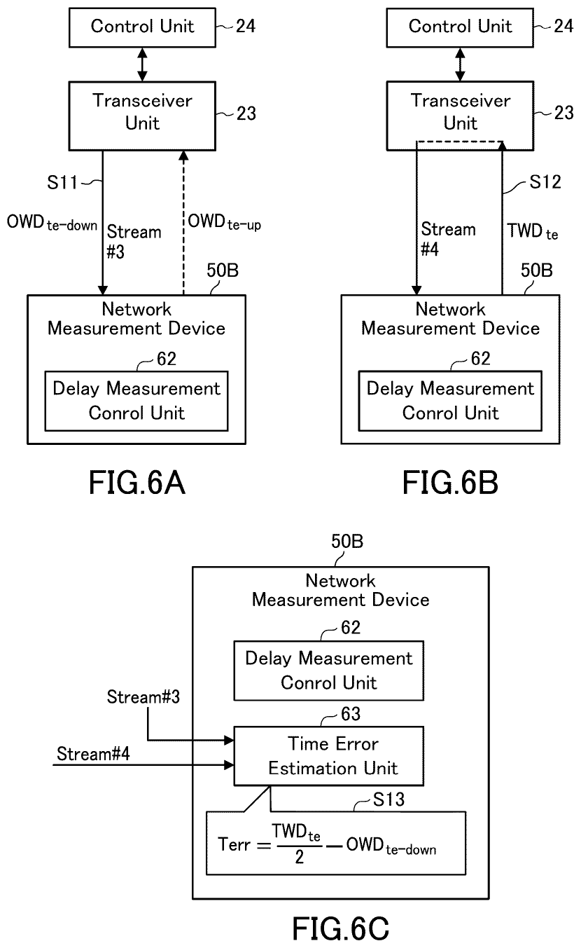

The measurement module 54 is a functional unit that executes various measurement processing operations targeting the communication network 1. The measurement operations performed by the measurement module 54 include measuring one-way delay (OWDᵤₚ, OWD_{down}) for a predetermined delay measurement section of the communication network 1 (see FIGS. 1 and 5), estimating one-way delay (OWDₜₑ₋ᵤₚ, OWD_{te-down}) between the server device 22 and the measurement module 54 when the measurement module 54 is arranged (connected) to the server device 22, two-way delay (Two Way Delay: TWDₜₑ), and time error (Tₑᵣᵣ) (see FIG. 6).

The display operation unit 55 consists of a display function, an input operation function, and a touch panel that serves both functions. The display function of the display operation unit 55 displays various screens or information. The input operation function of the display operation unit 55 accepts various instruction operations, such as setting measurement conditions for one-way delay measurement, and instructions to start and stop one-way delay measurement and the like.

The storage unit 56 stores various information, such as various control information required for one-way delay measurement, programs executed to achieve the functions of the setting control unit 60, positioning control unit 61, delay measurement control unit 62, and display control unit 64 in the control unit 57 described later, various control information required for the delay measurement control unit 62 to measure one-way delay and two-way delay between the server device 22 and estimate the time error Tₑᵣᵣ, and information on the measurement results.

The control unit 57 controls the entire network measurement device 50A and comprises the setting control unit 60, positioning control unit 61, delay measurement control unit 62, and display control unit 64.

The setting control unit 60 is a processing functional unit that accepts setting operations performed by the input operation function of the display operation unit 55 and sets various information corresponding to the setting operations. The setting control unit 60 is a functional unit that performs various settings related to, for example, one-way delay measurement of the one-way delay section, one-way delay measurement and two-way delay measurement between the server device 22, and conditions related to the estimation of the time error Tₑᵣᵣ.

The positioning control unit 61 is a functional unit that performs positioning at the location based on the received signal information by the GNSS antenna 45. The positioning control unit 61 also performs processing to extract UTC from the signal processing result by the signal processing device 53 of the received signal information received by the GNSS receiver 52, for example.

The delay measurement control unit 62 drives and controls the measurement module 54 to perform measurement operations such as one-way delay measurement (see FIG. 5) targeting the one-way delay measurement section of the communication network 1 based on the settings by the setting control unit 60. After the one-way delay measurement described above is completed, the delay measurement control unit 62 may perform processing to store the measurement results (measurement data) of the one-way delay measurement in a predetermined storage area of the storage unit 56, for example, so that the measurement results can be collected from the outside later (see FIG. 7 and FIG. 8).

The display control unit 64 performs control to display various information on the display function of the display operation unit 55, such as the measurement conditions set by the setting control unit 60, the positioning information acquired by the positioning control unit 61, and the one-way delay measurement results for the one-way delay section from the delay measurement control unit 62.

The transceiver unit 58 transceives signals conforming to a predetermined communication standard with the UE 10 connected to the network measurement terminal 59. An example of the predetermined communication standard is Ethernet, and the like.

(Network measurement device 50B) Next, the configuration of the network measurement device 50B will be described with reference to FIG. 3. In FIG. 3, a configuration is shown assuming that the network measurement device 50A is connected to the UE 10, while the network measurement device 50B is connected to the server device 22 via the network measurement terminal 59 and operated. In FIG. 3, the similar reference numerals are used for the parts similar to those of the network measurement device 50A shown in FIG. 2.

As shown in FIG. 3, network measurement device 50B is constituted by functional blocks equivalent to those of network measurement device 50A, except that a time error estimation unit 63 is provided as a component of control unit 57. However, in the control unit 57 of network measurement device 50B, when the network measurement device 50B is connected to server device 22 and in operation, delay measurement control unit 62 controls, based on the settings in setting control unit 60, to perform measurement operations such as one-way delay measurement between server device 22 and two-way delay measurement (see FIGS. 6A and 6B), in addition to one-way delay measurement operation targeting the one-way delay measurement section.

The time error estimation unit 63 is a functional unit that performs a process (see FIG. 6C) of estimating the time error Tₑᵣᵣ of the server device 22 based on the measurement results of the one-way delay measurement and two-way delay measurement control between the server device 22 performed by the delay measurement control unit 62.

It should be noted that, in the network measurement device 50B, the delay measurement control unit 62 may be adapted to store the measurement results of the one-way delay measurement described above and the measurement results (measurement data) of the one-way delay measurement and two-way delay measurement between the server device 22, for example, in a predetermined storage area of the storage unit 56 so that they can be collected from outside later (see FIGS. 7 and 8).

It should be noted that, in the configurations shown in FIGS. 2 and 3, it is assumed that the network measurement devices 50A and 50B are connected to the UE 10 and the server device 22, respectively, and perform one-way delay measurements, and the network measurement device 50B comprises a time error estimation unit 63, while the network measurement device 50A does not comprise a time error estimation unit 63. However, the network measurement devices 50A and 50B may also be operated while connected to the server device 22 and the UE 10, respectively and to accommodate such operation, both devices may be configured to comprise a time error estimation unit 63 (a similar configuration).

If network measurement devices 50A and 50B have a similar configuration, when performing one-way delay measurement targeting a one-way delay measurement section of the communication network 1, one of them is connected to one end of the one-way delay measurement section (the device that transmits the one-way delay measurement signal) and the other is connected to the other end of the one-way delay measurement section (the device that receives the one-way delay measurement signal) and operated. Here, network measurement devices 50A and 50B connected to one end and the other end may be interchanged. FIG. 1 illustrates an example in which, within the communication network 1, the network measurement device 50A is arranged so as to be connected to the UE 10, which is the sender of a signal related to one-way delay measurement, and network measurement device 50B is arranged so as to be connected to server device 22, which is arranged in a data center 30 and is the receiver of the signal related to one-way delay measurement.

In this case, network measurement device 50A is installed within the communication network 1 so as to connect UE 10 to network measurement terminal 59 (see FIG. 2), and the delay measurement control unit 62 drives and controls the UE 10 to transmit a one-way delay measurement signal to the server device 22, which is the other side.

In contrast, network measurement device 50B is installed within the communication network 1 so as to connect the transceiver unit 23 of the server device 22 to the network measurement terminal 59 (see FIG. 3), and the delay measurement control unit 62 captures the one-way delay measurement signal described above received by the transceiver unit 23 and performs one-way delay measurement between the UE 10 and the server device 22 based on the signal.

In contrast to the configuration shown in FIG. 1, it is also possible to arrange the network measurement device 50B to be connected to the UE 10 and the network measurement device 50A to be connected to the server device 22 within the communication network 1. In this case, the network measurement device 50B drives and controls the operation of the UE 10, and the network measurement device 50A accesses the transceiver unit 23 of the server device 22 to perform the one-way delay measurement.

(Server Device) FIG. 4 shows the connection between the network measurement device 50B and the server device 22 when the network measurement devices 50A and 50B having the configuration described above are arranged in the communication network 1 in the manner shown in FIG. 1, for example, and the detailed configuration of the server device 22.

As shown in FIG. 4, the server device 22 is configured to comprise the transceiver unit 23, the control unit 24, the storage unit 25, the operation unit 26, the display unit 27, and the clock 28.

The transceiver unit 23 comprises a signal transmitter 23a and a signal receiver 23b, and is connected to the base station 11 via the core network 21. In the transceiver unit 23, the signal transmitter 23a receives a signal, for example, intended for the UE 10 from the control unit 24 and transmits it to the core network 21, while the signal receiver 23b receives a signal from the UE 10 intended for the control unit 24 from the core network 21 and inputs it to the control unit 24.

In the server device 22, a network measurement device (for example, 50B) is connected to the path between the signal transmitter 23a and the signal receiver 23b and the core network 21, and the one-way delay measurement described above, or one-way and two-way delay measurement between the network measurement device 50B and the server device 22 is performed.

The control unit 24 controls the overall operation of the server device 22. As an example of control, for example, when performing the one-way delay measurement targeting the section between the UE 10 and the server device 22, the control unit 24 performs the one-way delay measurement while transmitting and receiving control signals, and the like, through the transceiver unit 23 to the delay measurement control unit 62 of network measurement device 50B connected to the path described above (that is, in cooperation with the delay measurement control unit 62). Also, the control unit 24 cooperates with the delay measurement control unit 62 of the network measurement device 50B to perform control of the one-way and two-way delay measurement between the server device 22, and the time error estimation of the server device 22. Here, when performing the one-way delay measurement between the UE 10 and the server device 22, the one-way and two-way delay measurement between the server device 22, and the time error estimation of server device 22, the control unit 24 may store the measurement results (measurement data) in a predetermined storage area of the storage unit 25, for example, so that measurement results can be collected from the outside later (see FIGS. 7 and 8).

The storage unit 25 stores various data, such as a control program for causing the control unit 24 to execute the one-way delay measurements in the one-way delay measurement section, the one-way and two-way delay measurements between the network measurement devices 50B, measurement data for one-way delay measurements in the one-way delay measurement section, and measurement data for one-way and two-way delay measurements between the network measurement devices 50B.

The operation unit 26 is a functional unit for inputting various information such as commands. The display unit 27 is constituted by a liquid crystal panel or the like, and is a functional unit for displaying various information such as a screen related to the control of one-way delay measurements, measurement results, and the like.

The clock 28 is a functional unit for generating highly accurate clock information (time information). The server device 22 does not have a control function for synchronizing the time information generated by the clock 28 with UTC.

Next, the one-way delay measurement operation targeting the one-way delay section of the communication network 1 by the network measurement system 5 according to the present embodiment will be described with reference to the flowchart shown in FIG. 5.

In the network measurement system 5 according to the present embodiment, in order to perform the one-way delay measurement targeting the communication network 1 (see FIG. 1), the one-way delay measurement section is determined, and the network measurement device 50A is connected to the device that transmits the one-way delay measurement signal, and the network measurement device 50B is connected to the device that receives the one-way delay measurement signal (step S1).

Here, when the one-way delay measurement section is between the UE 10 and the server device 22, as shown in FIG. 1, the network measurement device 50A is connected to the UE 10, and the network measurement device 50B is connected to the server device 22, both in a state that allows one-way delay measurements.

Next, the network measurement conditions (one-way delay measurement conditions) are set for the network measurement devices 50A and 50B (step S2). This setting can be performed, for example, by the user operating a predetermined setting screen displayed on the display operation unit 55. Examples of the network measurement conditions to be set include the one-way delay measurement section (the device on one end and the device on the other end), the measurement direction which is uplink or downlink, and the measurement period, and the like.

Once the network measurement condition settings are completed and preparations are ready to start measurement, the network measurement device 50A performs an operation to instruct the network measurement device 50A to start measurement on the setting screen described above (step S3).

When the instruction to start measurement is accepted, the delay measurement control unit 62 in the control unit 57 of the network measurement device 50A drives and controls the UE 10 to transmit a one-way delay measurement signal from the UE 10, which is the device on one end, to the server device 22, which is the device on the other end, based on the setting in step S2 above, for example, if the measurement direction is uplink. At that time, the network measurement device 50A also performs control to add a timestamp indicating the transmission time of the one-way delay measurement signal to the one-way delay measurement signal (step S4). The timestamp added at this time is time information acquired by processing information received by the GNSS receiver 52 in the network measurement device 50A from the GPS (Global Positioning System) 40 through the GNSS antenna 45.

The one-way delay measurement signal transmit from the UE 10 in step S4 above is transmitted to the server device 22 through a path corresponding to the predetermined one-way delay measurement section of the communication network 1. Specifically, in the configuration of the communication network 1 shown in FIG. 1, the one-way delay measurement signal sent from the UE 10 is transmitted, for example, using Stream #2 through the base station 11, the core network 21, and the path passing through the transceiver unit 23 in the server device 22.

During the transmission of the one-way delay measurement signal by Stream #2 in step S4 above, the delay measurement control unit 62 in the transceiver unit 23 of the server device 22, more specifically, in the network measurement device 50B connected to the path immediately before the server device 22 (see FIG. 4), captures the one-way delay measurement signal being transmitted via the transceiver unit 58 and measurement module 54 (see FIG. 3) and imports the captured signal (step S5).

The delay measurement control unit 62 then extracts the timestamp added to the imported one-way delay measurement signal, and compares the time information indicated by the timestamp with the time information acquired by the GNSS receiver 52 on its own unit side by processing the information received from the GPS 40 by the GNSS antenna 45, and calculates as the one-way delay OWD_{up-raw} [ms] between the UE and the server device 22 (step S6).

The delay measurement control unit 62 then performs a process of storing the one-way delay OWD_{up-raw} calculated in step S6, for example, in a predetermined storage area set in the storage unit 56 (step S7).

The measurement of the one-way delay OWD_{up-raw} between the UE 10 and the server device 22 in steps S4 to S7 above is continued during the measurement period set in step S2 above, and when the measurement period ends, the series of one-way delay measurements targeting the uplink path between the UE 10 and the server device 22 ends.

In FIG. 5, the measurement operation of the one-way delay OWD_{up-raw} for the uplink path between UE 10 and server device 22 has been described, but the measurement operation of the one-way delay OWD_{down-raw} for the downlink path can also be performed using Stream #1 in a similar procedure (see FIG. 5) by setting server device 22 as one end device and UE 10 as the other end device for the similar section. However, in this case, network measurement device 50B instructs server device 22 to transmit a one-way delay measurement signal, and network measurement device 50A controls UE 10 to receive (capture) the signal.

Regarding one-way delay (OWD_{up-raw}, OWD_{down-raw}) measurement in the one-way delay measurement section shown in FIG. 5, in the configuration of the communication network 1 according to the present embodiment, the server device 22 on one side is arranged inside the data center 30 (see FIG. 1), so the one-way delay (OWDᵤₚ, OWD_{down}) measurement in the one-way delay measurement section using the network measurement devices 50A, 50B is arranged in an environment that is subjected to the time information acquired from the clock 28 of the server device 22.

In this regard, in the network measurement system 5 according to the present embodiment, as will be described in detail later, the network measurement device on one side (for example, 50B) has the function of estimating the time error Tₑᵣᵣ of the server device 22 from the measurement results of the one-way delay measurement between the server device 22 and the two-way delay measurement, and correcting the one-way delay (OWDᵤₚ, OWD_{down}). As a result, even if the network measurement devices 50A and 50B are arranged in an environment that is subjected to the time information acquired from the clock 28 of the server device 22, they can operate in an environment equivalent to when they can acquire time information synchronized with UTC. Therefore, it is possible to perform estimation of the time error of the one-end device while performing one-way delay measurement of the one-way delay measurement section under conditions of high time accuracy, and to perform accurate measurement of one-way delay taking into account the time error estimation result.

(Time Error Estimation Processing of the Server Device 22) Next, the estimation operation of the time error Tₑᵣᵣ of the server device 22 by the network measurement system 5 according to the present embodiment will be described. Here, the estimation operation of the time error Tₑᵣᵣ of the server device 22 performed in conjunction with the measurement of the one-way delay (OWDᵤₚ) targeting the uplink path in the one-way delay measurement section between the UE 10 and the server device 22, in particular, will be described as an example.

The estimation of the time error Tₑᵣᵣ of the server device 22 at this time can be performed by the delay measurement control unit 62 of the network measurement device 50B (see FIG. 3) connected to the transceiver unit 23 of the server device 22, which is the device at the other end of the one-way delay measurement section, exchanging signals with the control unit 24 of the server device 22.

As an example, in the present embodiment, the delay measurement control unit 62 and the control unit 24 of the server device 22 cooperate to simultaneously perform one-way delay measurement using Stream #3 established between them, and two-way delay measurement using Stream #4 (see FIGS. 6A and 6B), and estimate the time error Tₑᵣᵣ of the server device 22 from the measurement results of the one-way delay measurement and two-way delay measurement (see FIG. 6C).

The time error estimation processing of the server device 22 by the delay measurement control unit 62 will be described with reference to FIG. 6. In the network measurement device 50B, the delay measurement control unit 62 executes, for example, the control sequences shown in FIG. 6A and FIG. 6B between the control unit 24 of the server device 22 upon receiving a one-way delay measurement signal from the UE 10.

FIG. 6A shows an example of a one-way delay measurement control sequence between the delay measurement control unit 62 and the server device 22. As shown in FIG. 6A, one pattern of one-way delay measurement between the delay measurement control unit 62 and the server device 22 is a pattern in which the delay measurement control unit 62 establishes Stream #3 with the server device 22 and instructs the server device 22 to transmit a delay measurement signal for measuring the time error using Stream #3.

By receiving the above instruction, the control unit 24 of the server device 22 transmits a delay measurement signal for time error measurement with a time stamp added to the network measurement device 50B using Stream #3.

When the network measurement device 50B receives the delay measurement signal from the control unit 24 of the server device 22, the delay measurement control unit 62 performs a process of calculating the time equivalent to the difference between the two times from the reception time and the time information indicated by the time stamp added to the delay measurement signal as the downlink one-way delay OWD_{te-down}. Furthermore, the delay measurement control unit 62 stores the calculated one-way delay OWD_{te-down}, for example, in a predetermined storage area of the storage unit 56.

Here, an example is given in which the delay measurement control unit 62 and the control unit 24 of the server device 22 cooperate to calculate the downlink one-way delay OWD_{te-down}, but it is also possible to calculate the uplink one-way delay OWDₜₑ₋ᵤₚ in a similar manner, as shown by the dotted line in FIG. 6A. In addition, since only one of either OWD_{te-down} or OWDₜₑ₋ᵤₚ is required for the time error estimation processing of the server device 22 described later, OWD_{te-down} will be used below.

FIG. 6B shows an example of a two-way delay measurement control sequence between the delay measurement control unit 62 and the server device 22. As shown in FIG. 6B, in measuring the two-way delay between the server device 22, the delay measurement control unit 62 uses Stream #4 established between the control unit 24 of the server device 22 to transmit a delay measurement signal for time error measurement with a time stamp added to the control unit 24 of the server device 22. When the server device 22 receives the delay measurement signal, the control unit 24 returns the delay measurement signal and transmits it to the delay measurement control unit 62 of the network measurement device 50B using Stream #4.

When the delay measurement control unit 62 receives the delay measurement signal sent back from the server device 22, it performs a process of calculating the time equivalent to the difference between the reception time and the time information indicated by the time stamp added to the delay measurement signal as the two-way delay TWDte. Furthermore, the delay measurement control unit 62 stores the calculated two-way delay TWDₜₑ in a predetermined storage area of the storage unit 56, for example, in association with the one-way delay OWD_{te-down} (or OWDₜₑ₋ᵤₚ) already stored therein.

Furthermore, in the network measurement device 50B, the time error estimation unit 63 estimates the time error Tₑᵣᵣ of the server device 22 by the calculation shown in the following formula (1) based on the one-way delay time OWD_{te-down} (or OWDₜₑ₋ᵤₚ) and the two-way delay time TWDₜₑ acquired by the control sequence shown in FIGS. 6A and 6B (see FIG. 6C).

$${T}_{err} = T W {D}_{t e} / 2 - {OWD}_{te - down} \qquad ( 1 )$$

$$OW {D}_{down} = O W {D}_{down - raw} + {T}_{err} \qquad ( 2 )$$

$$OW {D}_{up} = O W {D}_{up - raw} - {T}_{e r r} \qquad ( 3 )$$

The following can be understood from the above formula (1). The time error Tₑᵣᵣ of server device 22 is equivalent to the value of half the two-way delay TWDₜₑ between network measurement device 50B minus the time error in the one-way delay between network measurement device 50B (for example, the downlink time error OWD_{te-down}).

On the other hand, the following can be understood from the above formulas (2) and (3) using the previously calculated OWD_{down-raw} and OWD_{up-raw} (see FIG. 1). The accurate one-way downlink delay OWD_{down} between UE 10 and server device 22 (in a state synchronized with UTC) can be considered to be the value acquired by adding the time error Tₑᵣᵣ of server device 22 calculated by the above formula (1) to the one-way downlink delay (actual measured value) OWD_{down-raw}. The accurate one-way uplink delay OWDᵤₚ between UE 10 and server device 22 (in a state synchronized with UTC) can be considered to be the value acquired by subtracting the time error Tₑᵣᵣ of server device 22 calculated by the above formula (1) from the one-way uplink delay (actual measured value) OWD_{up-raw}.

From these points, it can be understood that if the time error Tₑᵣᵣ of server device 22, which can be expressed by the above formula (1), is known, it is possible to use the above formulas (2) and (3) to correct the one-way uplink delay OWDᵤₚ and the one-way downlink delay OWD_{down} to accurate values when there is no time error Tₑᵣᵣ.

Here, the data on the uplink one-way delay OWD_{up-raw} is stored, for example, in the storage unit 56 of the network measurement device 50A, and the data on the downlink one-way delay OWD_{down-raw} and the time error Tₑᵣᵣ of the server device 22 are stored, for example, in a predetermined storage area of the storage unit 56 of the network measurement device 50B during execution of the control sequence described above (see FIG. 6).

As a result, in the network measurement system 5 according to the present embodiment, by reading out the data of the uplink one-way delay OWD_{up-raw}, the downlink one-way delay OWD_{down-raw}, and the time error Tₑᵣᵣ of the server device 22 in the one-way delay measurement section of the communication network 1 stored in each of the above storage areas, and performing a correction processing for the uplink one-way delay OWD_{up-raw} and the downlink one-way delay OWD_{down-raw} using the above formulas (1), (2), and (3), it becomes possible to calculate accurate values of the uplink one-way delay OWDᵤₚ and the downlink one-way delay OWD_{down} with the time error Tₑᵣᵣ of the server device 22 eliminated. Next, the one-way delay correction function comprised in the network measurement system 5 according to the present embodiment will be described.

(One-way delay correction function) The network measurement system 5 according to the present embodiment has a processing function for correcting the value of the one-way delay measured by the network measurement devices 50A and 50B based on the values of the one-way and two-way delay between the server device 22 measured by the network measurement device 50B, and the value of the time error Tₑᵣᵣ of the server device 22.

The process of correcting the value of the measured one-way delay is performed after one-way delay measurement by the two network measurement devices 50A and 50B, one-way and two-way delay measurement between the server device 22 by the other network measurement device 50B, and time error Tₑᵣᵣ estimation by the server device 22 are completed and the respective measurement data are stored, and then the measurement data is collected and analyzed.

For this reason, the network measurement system 5 according to the present embodiment has a configuration in which a data analysis processing device that collects measurement data from the network measurement devices 50A and 50B and analyzes the data is arranged outside the network measurement devices 50A and 50B described above. The arrangement of the data analysis processing device for achieving this configuration will be described with reference to FIGS. 7 and 8.

(First arrangement) The first arrangement of the data analysis processing device equipped with the one-way delay correction function in the network measurement system 5 according to the present embodiment is shown in FIG. 7.

In the first arrangement, the data analysis processing device 70 is achieved by an information processing device such as a PC having a communication function and an information processing function. In the example shown in FIG. 7, the data analysis processing device 70 is communicably connected to each of the network measurement devices 50A, 50B, and the server device 22. The data analysis processing device 70 comprises a data collection unit 71 that accesses the data storage areas of the network measurement devices 50A, 50B at a predetermined timing after the one-way delay measurement between the UE 10 and the server device 22, the one-way and two-way delay measurement between the server device 22, and the time error Tₑᵣᵣ estimation of the server device 22 are completed, and collects and analyzes the measurement data stored in the data storage area of each unit. The data collection unit 71 constitutes the collection means of the present invention.

Specifically, as shown in FIG. 7, the data collection unit 71 accesses the storage unit 56 of the network measurement device 50A, and collects from the data storage area one-way delay data Da (=ODWdown_raw) in the downlink direction between the UE 10 and the server device 22.

The data collection unit 71 also accesses the storage unit 56 of the network measurement device 50B, and collects from the data storage area one-way delay data Db (=ODW_{up_raw}) in the uplink direction between the UE 10 and the server device 22. Furthermore, the data collection section 71 accesses the data storage area that stores the one-way delay data Dc (=OWD_{te-down} (or OWDₜₑ₋ᵤₚ)), two-way delay data Dd (=TWDₜₑ), and time error data De (=Tₑᵣᵣ) of the server device 22 with the server device 22 between the storage section 56 of the network measurement device 50B, and also performs processing to collect each of the data Dc, Dd, and De.

It should be noted that the network measurement system 5 according to the present embodiment may be configured such that the one-way delay data Dc (=OWD_{te-down} (or OWDₜₑ₋ᵤₚ), two-way delay data Dd (=TWDₜₑ), and time error data De (=Tₑᵣᵣ) of the server device 22 between the server device 22 is stored in the storage unit 25 (see FIG. 4) of the server device 22. In this case, as shown by the measurement data (Dc, Dd, De) in parentheses between the server device 22 and the data analysis processing device 70 in FIG. 7, the data collection unit 71 accesses the storage unit 25 of the server device 22 and collects the one-way delay data Dc (=OWD_{te-down} (or OWDₜₑ₋ᵤₚ)), two-way delay data Dd (=TWDₜₑ), and the time error data De (Tₑᵣᵣ) of the server device 22 between the server device 22 stored in the data storage area.

After collecting each measurement data from the network measurement devices 50A, 50B (or the server device 22) as described above, the data analysis processing device 70 executes a process of correcting the one-way delay measurement data (=ODWdown_raw, ODWup_raw) of the one-way delay measurement section (between UE 10 and server device 22) on the communication network 1 using the collected measurement data.

To achieve this, the data analysis processing device 70 comprises a one-way delay correction unit 72. The one-way delay correction unit 72 performs processing to correct the one-way delay data Da and Db collected from network measurement devices 50A and 50B, using the one-way delay data Dc, the two-way delay data Dd, and the time error data De of the server device 22 collected from the network measurement device 50B (or the server device 22). One-way delay correction unit 72 constitutes the one-way delay correction means of the present invention.

Here, it is assumed that the value of the time error data De (=Tₑᵣᵣ) of server device 22 collected from network measurement device 50B (or server device 22) is calculated by the above formula (1) (Tₑᵣᵣ=TWDₜₑ/2−OWD_{te-down}). At this time, the one-way delay correction unit 72 uses the time error data De (=Tₑᵣᵣ) of the server device 22 collected from the network measurement device 50B (or the server device 22) as the correction value (OWD_{down}) of the downlink one-way delay data Da (=OWD_{down_raw}) collected from the network measurement device 50A, and can derive the following value from the above formula (2).

$$O W {D}_{down} = O W {D}_{down - raw} + {T}_{e r r}$$

Meanwhile, for the correction value (OWDᵤₚ) of the uplink one-way delay data Db (=OWD_{up_raw}) collected from the network measurement device 50B, the one-way delay correction unit 72 uses the value of the time error data De (=Tₑᵣᵣ) of the server device 22 collected from the network measurement device 50B (or the server device 22) and can derive the following value from the above formula (2).

$$O W {D}_{up} = O W {D}_{up - raw} - {T}_{e r r}$$

The one-way delay correction processing by the one-way delay correction unit 72 described above makes it possible to change a situation in which one of the network measurement devices (for example, 50B) connected to the server device 22 can only acquire one-way delay data (OWD_{up-raw}, OWD_{down-raw}) that includes time errors by using inaccurate time information acquired from the clock 28 (see FIG. 4) of the server device 22, into a situation in which acquisition of accurate one-way delay data (OWDᵤₚ, OWD_{down}) without time error Tₑᵣᵣ can be achieved, which is equivalent to the situation when the network measurement devices 50A, 50B perform one-way delay measurements while synchronizing with each other to UTC acquired from the GPS 40. By having this one-way delay correction function, in the network measurement system 5 according to the present embodiment, even in a situation where one side of the one-way delay measurement section of the communication network 1 is arranged, for example, in the data center 30, making it difficult to perform one-way delay measurements synchronized with UTC on both sides, it becomes possible to more accurately measure the one-way delay in the one-way delay measurement section between the server device 22 and the UE 10.

(Second arrangement) second arrangement of the data analysis processing device equipped with the one-way delay measurement value correction function in the network measurement system 5 according to the present embodiment is shown in FIG. 8.

In the second arrangement, the server device 22 is provided with a data analysis processing device 70A having a function equivalent to that of the data analysis processing device 70 in the first arrangement. The data analysis processing device 70A is communicably connected to each part of the network measurement devices 50A and 50B. Similar to the data analysis processing device 70 described in the first arrangement, the data analysis processing device 70A has a function (a data collection function unit equivalent to the data collection unit 71) that accesses the data storage areas of the network measurement devices 50A, 50B at a predetermined timing after the one-way delay measurement between the UE 10 and the server device 22, the one-way and two-way delay measurement between the server device 22, and the time error Tₑᵣᵣ estimation of the server device 22 are completed, and collects the measurement data stored in the data storage area of each unit.

Specifically, as shown in FIG. 8, this data collection function unit collects downlink one-way delay data Da (=ODWdown_raw) between the UE 10 and the server device 22 from the data storage area of the network measurement device 50A.

The data collection function unit also collects one-way delay data Db (=ODW_{up_raw}) in the uplink direction between UE 10 and server device 22 from the data storage area of network measurement device 50B, and also collects one-way delay data Dc (=OWD_{te-down} (or OWDₜₑ₋ᵤₚ)) between server device 22, two-way delay data Dd (=TWDₜₑ), and time error data De (=Tₑᵣᵣ) of server device 22.

The server device 22 can also be configured to store each of these data Dc, Dd, and De, in its own, such as the storage unit 25 (see FIG. 4), instead of the network measurement device 50B storing the one-way delay data Dc (=OWD_{te-down} (or OWDₜₑ₋ᵤₚ) between the server device 22, two-way delay data Dd (=TWDₜₑ), and time error data De (=Tₑᵣᵣ) of server device 22. In this case, as shown by the measurement data (Dc, Dd, De) in parentheses associated with the server device 22 in FIG. 8, the data collection function unit of the data analysis processing device 70A accesses the storage unit 25 of the server device 22 and collects the one-way delay data Dc (=OWD_{te-down} (or OWDₜₑ₋ᵤₚ)), two-way delay data Dd (=TWDₜₑ), and the time error data De (Tₑᵣᵣ) of the server device 22 stored in the data storage area.

After collecting each measurement data from the network measurement devices 50A, 50B (or the server device 22), the data analysis processing device 70A executes a process of correcting the one-way delay measurement data (=ODWdown_raw, ODWup_raw) of the one-way delay measurement section (between UE 10 and server device 22) on the communication network 1 using the collected measurement data.

To perform this process, the data analysis processing device 70A has a one-way delay correction function equivalent to the one-way delay correction unit 72 of the data analysis processing device 70 described in the first arrangement. As a result, in the data analysis processing device 70A, the one-way delay correction function unit uses the time error data De (=Tₑᵣᵣ=TWDₜₑ/2−OWD_{te-down}) of the server device 22 collected from the network measurement device 50B (or the server device 22) and the above formulas (2) and (3) to calculate the correction value (OWD_{down}) of the downlink one-way delay data Da (=OWD_{down_raw}) collected from the network measurement device 50A and the correction value (OWDᵤₚ) of the uplink one-way delay data Db (=OWD_{up_raw}) collected from the network measurement device 50B, respectively, as follows.

$$O W {D}_{down} = O W {D}_{down - raw} + {T}_{e r r}$$

$$OW {D}_{up} = O W {D}_{up - raw} - {T}_{e r r}$$

In the one-way delay correction processing by the one-way delay measurement correction function unit of the data analysis processing device 70A of the server device 22 described above, as in the one-way delay correction processing by the one-way delay correction unit 72 of the data analysis processing device 70 relating to the first arrangement, even in a situation where one side of the one-way delay measurement section of the communication network 1 is arranged, for example, in the data center 30, making it difficult to perform one-way delay measurements synchronized with UTC on both sides, it becomes possible to more accurately measure the one-way delay in the one-way delay measurement section between the server device 22 and the UE 10.

It should be noted that the correction processing of the one-way delay OWDᵤₚ and OWD_{down} described above may be configured to be performed by other modules, not just the PC (see FIG. 7) or the server device 22 (see FIG. 8), as long as it has the ability to access the storage areas where the network measurement device 50A stores the downlink one-way delay data Da (=OWD_{down_raw}), the network measurement device 50B stores the uplink one-way delay data Db (=OWD_{up_raw}), and the network measurement device 50B or the server device 22 stores the time error value Tₑᵣᵣ of the server device 22.

Next, a specific example will be given of the estimation results of the one-way delay and the time error Tₑᵣᵣ by the network measurement system 5 according to the present embodiment.

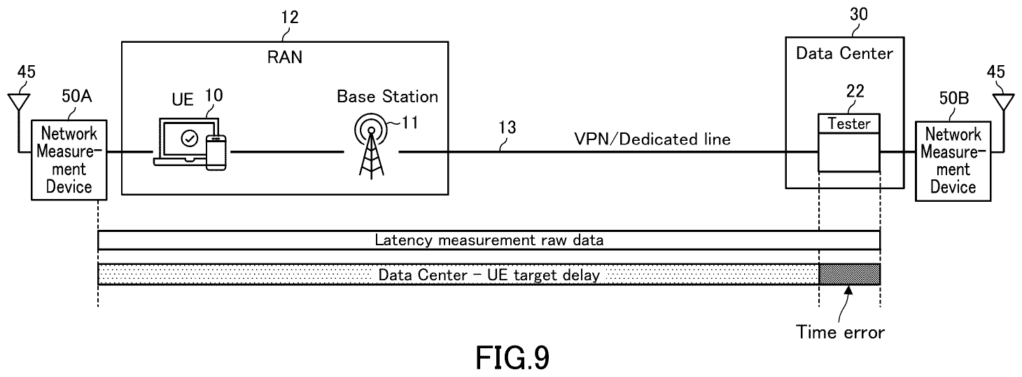

FIG. 9 is an image diagram showing the structure of the data transmission path and the transmission data corresponding to the one-way delay measurement section of the communication network 1 shown in FIG. 1. As shown in FIG. 9, the one-way delay measurement section of the communication network 1 shown in FIG. 1 is configured as a RAN (Radio Access Network) 12 that accommodates the UE 10 such as a smartphone or a PC in the wireless communication area of a base station (NB) 11, and the RAN 12 is assumed to be communicatively connected to a data center (Data Center) 30 through a dedicated line, for example, a virtual private network (VPN) 13 (corresponding to the access network 15 in FIG. 1).

When estimating one-way delay and time error Tₑᵣᵣ between a data center 30 and a UE 10 (Data Center-UE) corresponding to 5G in the data transmission path assumed here, one (network measurement device 50A) of the two network measurement devices 50A and 50B that constitute the network measurement system 5 of the present embodiment is connected to the UE 10, and the other (network measurement device 50B) is connected to the server device 22 in the data center 30.

In FIG. 9, the data to be measured for one-way delay in the network measurement system 5 of the present embodiment is the latency measurement raw data transmit from the network measurement device 50A and transmitted through the RAN 12 and virtual private network 13 to the server device 22 in the data center (Data Center) 30, as disclosed in the lower part (middle part of FIG. 9) in association with the data transmission path described above (upper part of FIG. 9).

This measurement target data (Latency measurement raw data) includes, as elements that cause delay, the delay between the network measurement device 50A and the entrance of the server device 22 in the data center 30 (Data Center-UE Target delay) and the time error (Time error) Tₑᵣᵣ in the server device 22, as disclosed in the bottom row of FIG. 9.

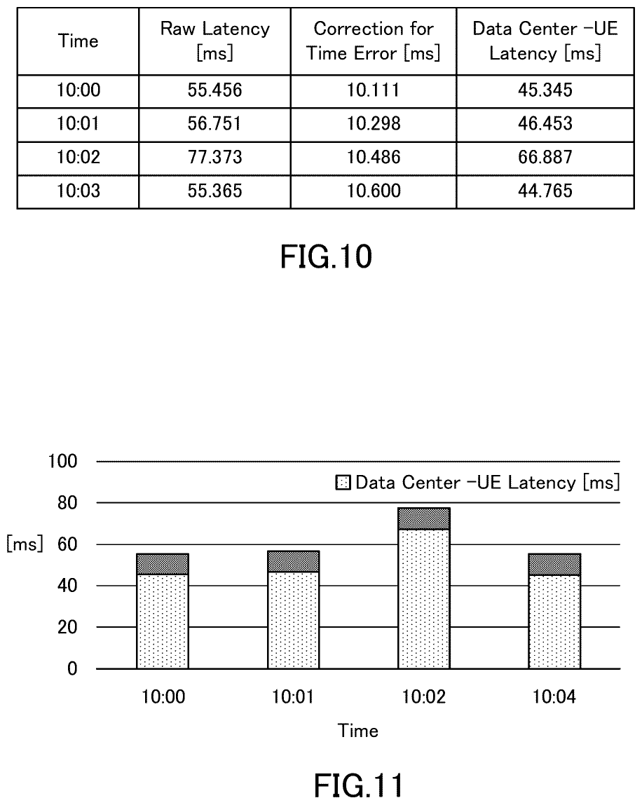

In the communication environment shown in FIG. 9, the network measurement system 5 according to the present embodiment was used to measure the one-way delay between the Data Center-UE (see FIG. 5) and estimate the time error Tₑᵣᵣ in the server device 22 in the data center 30 (see FIG. 6), to obtain the measurement results shown in the table in FIG. 10.

In FIG. 10, Time indicates the measurement time. In this example, examples are measurements taken at 10:00, 10:01, 10:02, and 10:03.

Raw Latency indicates the delay time (Latency measurement raw data) shown in the middle of FIG. 9, and is expressed in milliseconds [ms].

Correction for Time Error indicates the value of the time error Tₑᵣᵣ of the server device 22 measured in the data center 30, and is shown in the lower right corner of FIG. 9, and is expressed in milliseconds [ms].

Data Center-UE Latency is the one-way delay time between the data center and the UE, and is shown in the lower left corner of FIG. 9 (adjacent to the time error Tₑᵣᵣ), and is expressed in milliseconds [ms].

As can be seen from the table in FIG. 10, the one-way delay time of the data (Latency measurement raw data) transmitted through the one-way delay measurement section shown in FIG. 9 is measured as the sum of value of the time error Tₑᵣᵣ of the server device 22 and the value of the one-way delay time between the data center and the UE.

According to the table in FIG. 10, when estimating the one-way delay and time error targeting between the data center and the UE shown in FIG. 9, the one-way delay was measured at 10:00, 10:01, 10:02, and 10:03, respectively, as 55.456 [ms], 56.751 [ms], 77.373 [ms], and 55.365 [ms].

More specifically, the one-way delay of 55.456 [ms] measured at 10:00 was broken down into a time error Tₑᵣᵣ value of 10.111 [ms] and a one-way delay time between the data center and the UE of 45.345 [ms].

The one-way delay of 56.751 [ms] measured at 10:01 was broken down into a time error Tₑᵣᵣ value of 10.298 [ms] and a one-way delay time between the data center and the UE of 46.453 [ms].

The one-way delay of 77.373 [ms] measured at 10:02 was broken down into a time error Tₑᵣᵣ value of 10.486 [ms] and a one-way delay time between the data center and the UE of 66.887 [ms]. Further, the one-way delay of 55.365 [ms] measured at 10:03 was broken down into a time error Tₑᵣᵣ value of 10.600 [ms] and a one-way delay time between the data center and the UE of 44.765 [ms].

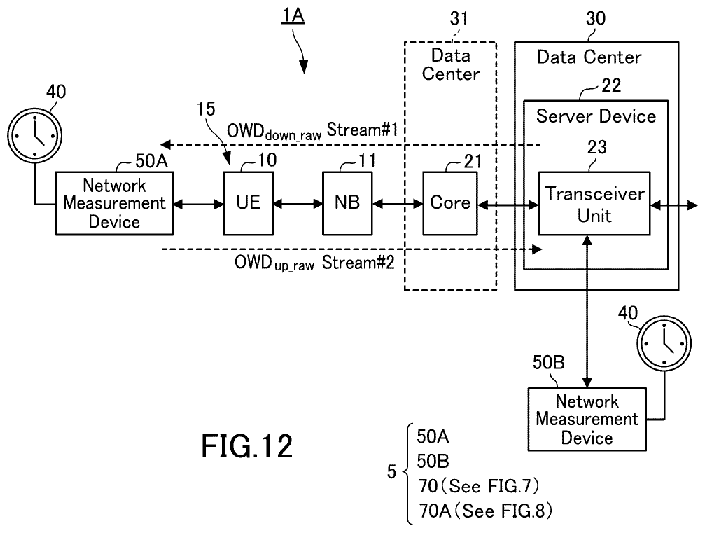

The one-way delay measurement results and time error estimation results shown in the table in FIG. 10 are drawn into the graph of FIG. 11. In this graph, the horizontal axis indicates the measurement time (units: hours and minutes), and the vertical axis indicates the one-way delay. The one-way delay on the vertical axis is represented by a single bar graph that distinguishes between the value of the Data Center-UE Latency and the value of the time error Tₑᵣᵣ.

The graphs of one-way delay measurement results and time error estimation results shown in FIG. 11 show that, as shown by the shape of each bar (represented by the value of Data Center-UE Latency+the value of time error Tₑᵣᵣ), the value of Data Center-UE Latency can be corrected to an accurate value by subtracting the value of time error Tₑᵣᵣ from the total value of one-way delay.

(Application of one-way delay correction function) As disclosed and explained in FIGS. 7 and 8, the network measurement devices 50A and 50B constituting the network measurement system 5 according to the present embodiment measure the downlink one-way delay data Da (=OWD_{down_raw}) and the uplink one-way delay data Db (=OWD_{up_raw}) according to the flowchart shown in FIG. 5, and store these measurement data Da and Db. In addition, the network measurement device 50B (or the server device 22) estimates and stores the value of the time error Tₑᵣᵣ of the server device 22. Furthermore, in the network measurement system 5 according to the present embodiment, a data analysis processing device 70 (see FIG. 7) or a data analysis processing device 70A (see FIG. 8) is arranged outside the network measurement devices 50A and 50B, and these devices collect and analyze the measurement data stored as described above, thereby making it possible to measure an accurate one-way delay (see the above formulas (2) and (3)) that is corrected by processing synchronized with UTC and is not subjected to the time error Tₑᵣᵣ of the server device 22.

(Regarding measures against fluctuations in one-way delay measurement results) According to the one-way delay measurement results and the time error estimation results shown in the table of FIG. 10, it can be seen that the delay increases or decreases. In addition, from such measurement results, it is quite conceivable that the delay may suddenly increase or decrease significantly.

In order to improve the accuracy of one-way delay measurement, it is preferable to suppress the temporal fluctuations in delay described above or sudden, sharp fluctuations in delay as much as possible. As a countermeasure for this, for example, a method is considered in which the average value of the one-way delay measurement value within a predetermined period is calculated and the average value is used as the measurement value (one-way delay measurement result). In addition, when sudden fluctuations are expected, for example, a threshold value (such as the average value described above) is set in advance, and when a delay exceeding the predetermined threshold is measured, the delay is excluded from the measurement value (i.e., the measurement value is not output). In either case, it is possible to eliminate the cause of sudden changes and stabilize the one-way delay measurement.

In the above embodiment, an example of a configuration in which the UE 10 and the base station (NB) 11 can communicate with each other through a wireless line is given as the communication network 1 to be subjected to one-way delay, but it is not limited to this, and the UE 10 and the base station (NB) 11 may be connected by a wired line.

In addition, in the above embodiment, a measurement method in which the one-way delay time is positive is exemplified, but the one-way delay measurement method of the present invention can also be applied to a case in which the one-way delay time is native (when there is no delay and the time is advancing). When the delay time is negative (when the time is advanced), it can be dealt with by performing the opposite calculation to when there is a delay time.

Above, one embodiment of the network measurement system 5 according to the present invention, which is based on the assumption that the communication network 1 has the configuration shown in FIG. 1, has been described (see FIGS. 2 to 11). The present embodiment is merely an example, and the network measurement system 5 according to the present invention can handle the various measurement operations described above even if the communication network 1 has a different configuration from that shown in FIG. 1 (or even if it is a normal network other than 5G).

FIG. 12 shows an example of the configuration of another communication network 1A that can be measured by the network measurement system 5 according to the present invention. In FIG. 12, the same components as those shown in FIG. 1 are given the same reference numerals. As shown in FIG. 12, this communication network 1A differs from the communication network 1 shown in FIG. 1 (see FIG. 1) in that the core network 21 and the server device 22 are provided in different data centers 31 and 30, respectively.

As can be understood by referring to FIGS. 1 and 12, in a communication network that can be handled by the network measurement system 5 according to the present embodiment, the core network 21 and the server device 22 do not necessarily have to be provided in the same data center 30 as shown in FIG. 1, but may be provided in separate data centers 31, 30 as shown in FIG. 12. It is also assumed that the core network 21 is not arranged in the data center 31. The network measurement system 5 according to the present embodiment is capable of performing the similar measurements as those shown in FIG. 1 in the case with the arrangement of each unit, even when targeting the core network 21 with the arrangement of each unit shown in FIG. 12.

As explained above, the network measurement system 5 according to the present embodiment measures the one-way delay between the edge that connects the server device 22 connected to the network and the terminal (UE 10, PC, and the like.).

The network measurement system 5 according to the present embodiment is a network measurement system for measuring one-way delay (OWDᵤₚ, OWD_{down}) in a one-way delay measurement section between a UE 10, and a server device 22, connected to a network, wherein the server device 22 and the terminal respectively have an acquisition means for acquiring time information as a common clock, and the system comprises a first network measurement device 50A and a second network measurement device 50B that are connected to the UE 10 or the server device 22 and measure the one-way delay in an environment subjected to the time information acquired from a clock 28 of the server device 22, wherein the first network measurement device 50A and the second network measurement device 50B further comprising: a delay measurement control unit 62 for performing a one-way delay measurement based on a delay measurement signal for time error measurement and a two-way delay measurement in parallel with the server device 22 in conjunction with the one-way delay measurement while connected to the server device 22; and a time error estimation means 63 for estimating a time error (Tₑᵣᵣ) of the server device 22 reflecting the time error between the time information of the common clock acquired by the acquisition means and the time information acquired from the clock 28 of the server device 22, based on the measurement results (OWD_{te-down}, OWDₜₑ₋ᵤₚ, and TWDₜₑ) of the one-way delay measurement and the two-way delay measurement performed by the delay measurement control unit 62.

By this configuration, the network measurement system 5 according to the present embodiment can operate in an environment equivalent to when both network measurement devices 50A, 50B can acquire time information from a common clock, even in an environment where one end of the one-way delay measurement section (for example, the server device 22 side) has difficulty acquiring time information from a common clock, by correcting the one-way delay due to the time error of the server device 22's clock. This makes it possible to perform estimation of the time error of the one-end device while performing one-way delay measurement of the one-way delay measurement section under conditions of high time accuracy, and to perform accurate measurement of one-way delay taking into account the time error estimation result.

In the network measurement system 5 according to the present embodiment, the common clock is Coordinated Universal Time (UTC), and a GNSS receiver 52 is provided as the acquisition means. By this configuration, the network measurement system 5 according to the present embodiment can operate in an environment equivalent to when both network measurement devices 50A, 50B can acquire time information synchronized with UTC, and makes it possible to perform accurate measurement of one-way delay taking into account the time error estimation result of the time error of the one-end device under conditions of high time accuracy.

Further, in the network measurement system 5 of the present embodiment, the network may be configured to be a communication network 1 comprising a core network 21 of a predetermined communication method and an access network 15 for enabling the UE 10 to access the core network 21, wherein the server device 22 is connected to the core network 21, is arranged within the data center 30, and measures the one-way delay related to data transmission between the UE 10 and the server device 22, for example.

By this configuration, the network measurement system 5 according to the present embodiment can accurately measure the one-way delay between a server device 22 in a data center 30 and a terminal at the edge of the network (UE 10, PC, and the like.) via a communication network 1.

Further, in the network measurement system 5 according to the present embodiment, the access network 15 is configured to comprise a base station 11 that accommodates the UE 10, for example to enable communication, and the base station 11 and the UE 10 are connected either by wire or wirelessly.

By this configuration, the network measurement system 5 according to the present embodiment can measure the one-way delay between the UE 10, for example and a server device 22 in the communication network 1 in the similar procedure, regardless of whether the base station 11 and the UE 10 are connected by wire or wirelessly in the access network 15, for example.

Further, in the network measurement system 5 according to the present embodiment, the core network 21 is configured to be constituted by one of private 5G, local 5G, and 5G core networks.

By this configuration, the network measurement system 5 according to the present embodiment can perform more accurate one-way delay measurements for communication networks 1 including core networks such as private 5G, local 5G, and 5G core networks.

Further in the network measurement system 5 according to the present embodiment, the first network measurement device 50A and the second network measurement device 50B are configured to comprise a transceiver unit 58 that conforms to a predetermined communication standard and are connected to, for example, the UE 10 or the server device 22 via the communication network 1.

By this configuration, the network measurement system 5 according to the present embodiment can easily construct a system configuration for performing one-way delay measurements between the UE 10 and the server device 22, and one-way and two-way delay measurements between the server device 22.

Further, in the network measurement system 5 according to the present embodiment, the delay measurement control unit 62 is configured to perform one-way delay measurements in the one-way delay measurement section for a predetermined period and at a predetermined time interval, and outputs an average value of the one-way delay measurements in the period as the one-way delay measurement result.

By this configuration, the network measurement system 5 of the present embodiment can reduce the impact of the variations and eliminate the uncertainty of the one-way delay of the communication network 1, even if extreme variations occur in the one-way measurements for the one-way delay measurement section.

Further, in the network measurement system 5 of the present embodiment, the delay measurement control unit 62 is configured to control not to output the one-way delay measurement result when the average value exceeds a predetermined threshold.

By this configuration, the network measurement system 5 of the present embodiment can prevent the one-way delay measurement result from fluctuating beyond a predetermined threshold, allowing for highly accurate one-way delay measurement while also reducing the impact of time errors Tₑᵣᵣ on the estimated results.

The network measurement system 5 according to the present embodiment is further configured to comprise a data analysis processing device 70, 70A arranged to be capable of communicating with the first network measurement device 50A and the second network measurement device 50B, the data analysis processing device 70,70A comprising: a collection unit 71 for collecting a downlink one-way delay measurement result (OWD_{down}) from the server device 22 to, for example, the UE 10 by the first network measurement device 50A, an uplink one-way delay measurement result (OWDᵤₚ) from the UE 10 to the server device 22 by the second network measurement device 50B, and a time error estimation result (TWDte) of the server device 22; and a one-way delay correction unit 72 for analyzing the downlink one-way delay measurement result, the uplink one-way delay measurement result, and the time error estimation result of the server device 22 collected by the collection unit 71, and correcting the downlink one-way delay measurement result and the uplink one-way delay measurement result based on the time error estimation result of the server device 22.

By this configuration, in the network measurement system 5 according to the present embodiment can easily correct the downlink one-way delay measurement results and the uplink one-way delay measurement results based on the time error estimation result of the server device 22 after the one-way delay correction unit 72 of the data analysis processing device 70, 70A analyzes the downlink one-way delay measurement results, the uplink one-way delay measurement results and the time error estimation result of the server device 22 collected by the data collection unit 71, thereby achieving more accurate one-way delay measurement.

In addition, in the network measurement system 5 according to the present embodiment, the data analysis processing device 70A is configured to be provided in the server device 22 constituting the communication network 1. By this configuration, the network measurement system 5 according to the present embodiment can achieve a system configuration for achieving accurate one-way delay measurement simply and inexpensively.

In addition, in the network measurement system 5 according to the present embodiment, the data analysis processing device 70 is configured to be arranged outside the communication network 1 so as to be able to communicate with the first network measurement device 50A and the second network measurement device 50B.

By this configuration, the network measurement system 5 according to the present embodiment can arrange the data analysis processing device 70 in any position away from the first network measurement device 50A and the second network measurement device 50B, improving flexibility in constructing a system for achieving accurate one-way delay measurement.

Further, the network measurement method according to the present embodiment is a network measurement method for measuring one-way delay (OWDᵤₚ, OWD_{down}) in a one-way delay measurement section between the terminal (UE 10, PC, and the like.) connected to the communication network 1 and the server device 22 using a network measurement system 5 having the configuration described above, comprising: a connection step (S1) for connecting the first network measurement device 50A to, for example, the UE 10 and the second network measurement device 50B to the server device 22; one-way delay measurement steps (S4-S6) for measuring the one-way delay in the one-way delay measurement section in an environment in which the first network measurement device 50A and the second network measurement device 50B are subjected to the time information acquired from the clock 28 of the server device 22; delay measurement control steps (S11, S12) in which the second network measurement device 50B performs both one-way delay measurement and two-way delay measurement in parallel, based on the delay measurement signal for time error measurement between the second network measurement device 50B and the server device 22, in conjunction with the one-way delay measurement in the one-way delay measurement section; and a time error estimation step (S13) for estimating a time error (Tₑᵣᵣ) of the server device 22 that reflects the time error between the time information of the common clock acquired by the acquisition means and the time information acquired from the clock 28 of the server device 22, based on the measurement results (OWD_{te-down}, OWDₜₑ₋ᵤₚ, and TWDₜₑ) of the one-way delay measurement and the two-way delay measurement by the delay measurement control step.

By this configuration, the network measurement method according to the present embodiment can operate in an environment equivalent to when both network measurement devices 50A, 50B can acquire time information from a common clock, even in an environment where one end of the one-way delay measurement section (for example, the server device 22 side) has difficulty acquiring time information from a common clock, by correcting the one-way delay due to the time error of the server device 22's clock 28. This makes it possible to perform estimation of the time error of the one-end device while performing one-way delay measurement of the one-way delay measurement section under conditions of high time accuracy, and to perform accurate measurement of one-way delay taking into account the time error estimation result.

### INDUSTRY APPLICABILITY

As described above, the present invention has the effect of enabling accurate measurement of the one-way delay of a one-way delay measurement section, even in an environment where it is difficult for the devices at one end of the one-way delay measurement section of a communication network to acquire time information synchronized with UTC, for example, as a common clock, and is useful for a network measurement system and a network measurement method in general that operates by arranging two network measurement devices at one end and the other end of the one-way delay measurement section.

### Explanation of Reference Numerals

1, 1A Communication Network
5 Network Measurement System
10 User Equipment (UE) (Terminal)
11 Base Station (Nodeb)
12 RAN (Radio Access Network)
13 Virtual Private Network (VPN)
15 Access Network
21 Core Network
22 Server Device
23, 58 Transceiver unit
23a Signal Transmitter
23b Signal Receiver
24, 57 Control Unit
25, 56 Storage Unit
26 Operation Unit
27 Display Unit
28 Clock
30, 31 Data Center
40 GPS (Global Positioning System) Positioning System)
45 GNSS Antenna
50A Network Measurement Device (First Network Measurement Device)
50B Network Measurement Device (Second Network Measurement Device)
52 GNSS Receiver (Acquisition Means)
53 Signal Processing Device
54 Measurement Module
55 Display Operation Unit
60 Setting Control Unit
61 Positioning Control Unit
62 Delay Measurement Control Unit (Delay Measurement Control Means)
63 Time Error Estimation Unit (Time Error Estimation Means)
64 Display Control Unit
70, 70A Data Analysis Processing Device
71 Data Collection Unit (Collection Means)
72 One-Way Delay Correction Unit (One-Way Delay Correction Means)

What is claimed is:

1. A Network measurement system for measuring one-way delay (OWDᵤₚ, OWD_{down}) in a one-way delay measurement section between a terminal and a server device, connected to a network, wherein
the server device and the terminal respectively have an acquisition means for acquiring time information as a common clock, and the system comprises a first network measurement device and a second network measurement device that are connected to the terminal or the server device and measure the one-way delay in an environment subjected to a time information acquired from a clock of the server device, wherein
the first network measurement device and the second network measurement device further comprising: a delay measurement control means for performing a one-way delay measurement based on a delay measurement signal for time error measurement and a two-way delay measurement in parallel with the server device in conjunction with the one-way delay measurement while connected to the server device;
and a time error estimation means for estimating a time error (Tₑᵣᵣ) of the server device reflecting a time error between the time information of the common clock acquired by the acquisition means and the time information acquired from the clock of the server device, based on the measurement results (OWD_{te-down}, OWDₜₑ₋ᵤₚ, and TWDₜₑ) of the one-way delay measurement and the two-way delay measurement performed by the delay measurement control means.

2. The network measurement system according to claim 1, wherein
the common clock is a Coordinated Universal Time (UTC).

3. The network measurement system according to claim 1, wherein
the network is a communication network comprising a core network of a predetermined communication method and an access network for enabling the terminal to access the core network, wherein the server device is connected to the core network, is arranged within a data center, and measures the one-way delay related to data transmission between the terminal and the server device.

4. The network measurement system according to claim 2, wherein
the network is a communication network comprising a core network of a predetermined communication method and an access network for enabling the terminal to access the core network, wherein the server device is connected to the core network, is arranged within the data center, and measures the one-way delay related to data transmission between the terminal and the server device.

5. The network measurement system according to claim 3, wherein
the access network comprises a base station that accommodates the terminal to enable communication, and the base station and the terminal are connected either by wire or wirelessly.

6. The network measurement system according to claim 4, wherein
the access network comprises a base station that accommodates the terminal to enable communication, and the base station and the terminal are connected either by wire or wirelessly.

7. The network measurement system according to claim 3, wherein
the core network is constituted by one of a private 5G, a local 5G, and a 5G core network.

8. The network measurement system according to claim 3, wherein
the first network measurement device and the second network measurement device comprise a transceiver unit that conforms to a predetermined communication standard and are connected to the terminal or the server device via the communication network.

9. The network measurement system according to claim 4, wherein
the first network measurement device and the second network measurement device comprise a transceiver unit that conforms to a predetermined communication standard and are connected to the terminal or the server device via the communication network.

10. The network measurement system according to claim 1, wherein
the delay measurement control means performs one-way delay measurements in the one-way delay measurement section for a predetermined period and at a predetermined time interval, and outputs an average value of the one-way delay measurements in the period as the one-way delay measurement result.

11. The network measurement system according to claim 2, wherein
the delay measurement control means performs one-way delay measurements in the one-way delay measurement section for a predetermined period and at a predetermined time interval, and outputs an average value of the one-way delay measurements in the period as the one-way delay measurement result.

12. The network measurement system according to claim 11, wherein the delay measurement control means controls not to output the one-way delay measurement result when the average value exceeds a predetermined threshold.

13. The network measurement system according to claim 12, wherein
the delay measurement control means controls not to output the one-way delay measurement result when the average value exceeds a predetermined threshold.

14. The network measurement system according to claim 1, further comprising a data analysis processing device arranged to be capable of communicating with the first network measurement device and the second network measurement device, the data analysis processing device comprising: a collection means for collecting a downlink one-way delay measurement result (OWD_{down}) from the server device to the terminal by the first network measurement device, an uplink one-way delay measurement result (OWDᵤₚ) from the terminal to the server device by the second network measurement device, and a time error estimation result (TWDₜₑ) of the server device; and a one-way delay correction means for analyzing the downlink one-way delay measurement result, the uplink one-way delay measurement result, and the time error estimation result of the server device collected by the collection means, and correcting the downlink one-way delay measurement result and the uplink one-way delay measurement result based on the time error estimation result of the server device.

15. The network measurement system according to claim 2, further comprising a data analysis processing device arranged to be capable of communicating with the first network measurement device and the second network measurement device, the data analysis processing device comprising: a collection means for collecting a downlink one-way delay measurement result (OWD_{down}) from the server device to the terminal by the first network measurement device, an uplink one-way delay measurement result (OWDᵤₚ) from the terminal to the server device by the second network measurement device, and a time error estimation result (TWDₜₑ) of the server device; and a one-way delay correction means for analyzing the downlink one-way delay measurement result, the uplink one-way delay measurement result, and the time error estimation result of the server device collected by the collection means, and correcting the downlink one-way delay measurement result and the uplink one-way delay measurement result based on the time error estimation result of the server device.

16. The network measurement system according to claim 15, wherein
the data analysis processing device is provided in the server device constituting the communication network.

17. The network measurement system according to claim 16, wherein
the data analysis processing device is provided in the server device constituting the communication network.

18. The network measurement system according to claim 15, wherein
the data analysis processing device is arranged outside the communication network so as to be able to communicate with the first network measurement device and the second network measurement device.

19. The network measurement system according to claim 16, wherein
the data analysis processing device is arranged outside the communication network so as to be able to communicate with the first network measurement device and the second network measurement device.

20. A network measurement method for measuring one-way delay (OWDᵤₚ, OWD_{down}) in a one-way delay measurement section between the terminal connected to the network and the server device using the network measurement system according to claim 1, comprising:
a connection step for connecting the first network measurement device to the terminal and the second network measurement device to the server device;
one-way delay measurement steps for measuring the one-way delay in the one-way delay measurement section in an environment in which the first network measurement device and the second network measurement device are subjected to a time information acquired from the clock of the server device;
delay measurement control steps in which the second network measurement device performs both one-way delay measurement and two-way delay measurement in parallel, based on the delay measurement signal for time error measurement between the second network measurement device and the server device, in conjunction with the one-way delay measurement in the one-way delay measurement section; and
a time error estimation step for estimating a time error (Tₑᵣᵣ) of the server device that reflects a time error between the time information of the common clock acquired by the acquisition means and the time information acquired from the clock of the server device, based on the measurement results (OWD_{te-down}, OWDₜₑ₋ᵤₚ, and TWDₜₑ) of the one-way delay measurement and the two-way delay measurement by the delay measurement control step.
